(19) United States
(12) Patent Application Publication
(10) Pub. No.: US 2026/0178632 A1
(43) Pub. Date: Jun. 25, 2026

(54) METHOD FOR OVERCOMING TOKEN CONSTRAINTS OF LANGUAGE MODELS APPLIED TO LARGE COMPUTATIONAL MATCHING TASKS

(71) Applicant: Intuit Inc., Mountain View, CA (US)

(72) Inventors: Shon MENDELSON, Tel Aviv (IL); Natalie Bar ELIYAHU, Petah Tikva (IL); Hadas BAUMER, Petah Tikva (IL); Omer WOSNER, Petah Tikva (IL)

(73) Assignee: Intuit Inc., Mountain View, CA (US)

(21) Appl. No.: 18/987,876

(22) Filed: Dec. 19, 2024

(51) Int. Cl. G06F 16/334; G06F 16/3329

(52) U.S. Cl. CPC G06F 16/3344; G06F 16/3329

(57) ABSTRACT

A method for executing a large matching task by a language model, the large matching task including a request to the language model to match a first dataset to a second dataset in which the request exceeds a maximum token constraint of the language model. A matching model generates matching scores from the first and second datasets. The matching scores represent probability of match between a first entry in the first dataset and one of a number of second entries in the second dataset. Selected candidate matches include matches between the first entry and a subset of the second entries for which the matching scores exceed a threshold value. A prompt is generated for the language model to identify a matching dataset set from among the candidate matches. The language model is executed with the prompt to output the matching dataset. The matching dataset is returned.

### BACKGROUND

Language models, such as large language models (e.g., CHATGPT® by Open AI, LLC) are increasingly used for a variety of computing tasks due to their versatility. Additionally, a language model may be subject to fewer retraining iterations, and thus may be less costly to operate.

However, language models have certain limitations. For example, one significant limitation is that a language model has a constraint on the maximum number of tokens that may be input into a language model. A “token” is a word, phrase, character, or other type of data, such as images or numbers.

While a large language model may have a token constraint between a few thousand tokens to about a million tokens, the limitation still may be a technical problem in some applications. For example, some matching tasks (i.e., matching a first dataset to a second dataset) could involve inputting millions or even billions of tokens to a language model. Furthermore, the most common language models have a token constraint of a few thousand tokens. Advanced language models with higher token constraints may be undesirable, because the computational cost of executing an advanced large language model may be prohibitive, and also because the monetary cost of accessing an advanced large language model may be prohibitive.

A computational task that exceeds a maximum token constraint of a language model (i.e., the language model selected to perform the computational task) may be referred to as a “large” computational task. Thus, by definition, the selected language model is incapable of performing a large computational task, as that computational task is defined with respect to the maximum token constraint.

Thus, a technical problem is presented. The technical problem is how to improve a computer to overcome token constraints of language models applied to large computational matching tasks.

### SUMMARY

One or more embodiments provide for a method for executing a large matching task by a language model, the large matching task including a request to the language model to match a first dataset to a second dataset in which the request exceeds a maximum token constraint of the language model. The method includes receiving a large matching task for a language model. The method also includes executing a matching model on the first dataset and the second dataset to generate a number of matching scores. Each of the matching scores represents a probability of match between a first entry in the first dataset and one of a number of second entries in the second dataset. The method also includes selecting a number of candidate matches between the first entry and a subset of the second entries. The matches have selected matching scores among the matching scores. The selected matching cores exceed a threshold value. The method also includes generating a prompt for the language model to identify a matching dataset set from among the candidate matches. The method also includes executing the language model with the prompt to output the matching dataset. The method also includes returning the matching dataset.

One or more embodiments provide for a system. The system includes a computer processor and a data repository in communication with the computer processor. The data repository stores a first dataset and a second dataset. The data repository also stores a large matching task including a request to match the first dataset to the second dataset. The request exceeds a maximum token constraint of a language model. The data repository also stores a number of matching scores. Each of the matching scores represents a probability of match between a first entry in the first dataset and one of a number of second entries in the second dataset. The data repository also stores a number of candidate matches. The candidate matches include matches between the first entry and a subset of the second entries that have selected matching scores among the matching scores. The selected matching scores exceed a threshold value. The data repository also stores a prompt for the language model to identify a matching dataset set from among the candidate matches, and the matching dataset. The system also includes the language model executable by the computer processor. The system also includes a matching model executable by the computer processor. The system also includes a server controller programmed, when executed by the computer processor, to perform a computer-implemented method. The computer-implemented method also includes receiving the large matching task. The computer-implemented method also includes executing the matching model on the first dataset and the second dataset to generate the matching scores. The computer-implemented method also includes selecting the candidate matches. The computer-implemented method also includes generating the prompt. The computer-implemented method also includes executing the language model with the prompt to output the matching dataset. The computer-implemented method also includes returning the matching dataset.

One or more embodiments provide for another method for executing a large matching task by a language model, the large matching task including a request to the language model to match a first dataset to a second dataset in which the request exceeds a maximum token constraint of the language model. The method includes receiving a large matching task for a language model. The large matching task includes a request, to match a first dataset to a second dataset, that exceeds a maximum token constraint of the language model. The method also includes executing a gradient boosting machine classifier on the first dataset and the second dataset to generate a number of matching scores. Each of the matching scores represents a probability of match between a first entry in the first dataset and one of a number of second entries in the second dataset. The gradient boosting machine classifier includes a slim matching model. The slim matching model includes a matching accuracy less than a predetermined matching accuracy specified for the large matching task. The language model includes at least the predetermined matching accuracy. The method also includes selecting a number of candidate matches between the first entry and a subset of the second entries. The matches have selected matching scores among the matching scores. The selected matching scores exceed a threshold value. The method also includes generating a prompt for the language model to identify a matching dataset set from among the candidate matches. Generating the prompt includes retrieving a prompt template including prompt instructions to match a first data subset and a second data subset. Generating the prompt also includes adding the first entry to the prompt as the first data subset. Generating the prompt also includes adding the second entries to the prompt as the second data subset. The method also includes executing the language model with the prompt to output the matching dataset. The method also includes repeating, for each additional entry in the first dataset, executing the matching model, selecting, generating, executing the language model, and returning. Repeating generates a number of matching datasets including the matching dataset. The method also includes returning the matching datasets.

Other aspects of one or more embodiments will be apparent from the following description and the appended claims.

### BRIEF DESCRIPTION OF DRAWINGS

FIG. 1 shows a computing system, in accordance with one or more embodiments.

FIG. 2 shows a flowchart of a method for overcoming token constraints in language models applied to matching tasks, in accordance with one or more embodiments.

FIG. 3A shows a dataflow of a method for training a matching model, in accordance with one or more embodiments.

FIG. 3B shows an example of a dataflow for a particular method for overcoming token constraints in language models applied to matching tasks, in accordance with one or more embodiments.

FIG. 4A through FIG. 4C shows example prompts for use in the method of FIG. 2 or the dataflow of FIG. 3B, in accordance with one or more embodiments.

FIG. 5A and FIG. 5B show a computing system and network environment, in accordance with one or more embodiments.

Like elements in the various figures are denoted by like reference numerals for consistency.

### DETAILED DESCRIPTION

One or more embodiments are directed to systems and methods for overcoming token constraints of language models when applied to large computational matching tasks. A matching task may be characterized, generally, as matching at least first entries in a first data set to at least second entries in a second dataset. For example, a bank statement (a first dataset, where each transaction in the bank statement is a “first entry”) may be matched to an electronic ledger (a second dataset, where each transaction in the electronic ledger is a “second entry”).

One or more embodiments refer to matching a first dataset to a second dataset for the sake of brevity. However, one or more embodiments are applicable to matching multiple datasets to each other and further to match multiple entries in each of the multiple datasets to one or more other datasets in one or more of the multiple datasets.

One or more embodiments may be described, in general, as follows: Initially, a large matching task for a language model is received.

However, instead of executing the matching task with the language model, a matching model is executed on the first and second datasets. The matching model may be a lightweight model. A “lightweight” matching model refers to a model that, when executed, uses less than a predetermined amount of computational resources, but which does not have a predetermined accuracy with respect to the large computational matching task.

The output of the matching model is a number of matching scores. Each matching score is a probability, estimated by the matching model, that one of the first entries in the first dataset matches one of the second entries in the second dataset. Thus, one matching score may be present for up to each first entry relative to each second entry.

Then, a number of candidate matches are selected from the output of the matching model. In particular, the candidate matches are those matches between the first entries and the second entries that have matching scores that satisfy a threshold value. In subsequent steps, the candidate matches are processed by the language model, while the remaining potential matches are not processed by the language model. In this manner, the total number of potential matches is greatly reduced. Accordingly, the total number of tokens that are input to the language model to perform the computational matching task are reduced below the maximum token constraint of the language model.

Next, a prompt is generated for the language model. The prompt commands the language model to identify a matching dataset from among the candidate matches. The language model is executed with the prompt to output a matching dataset, as the prompt has fewer tokens than the maximum token constraint of the language model. The matching dataset is then returned (e.g., stored, transmitted to another application for further processing, displayed to a user, etc.)

Thus, one or more embodiments solve the technical problem identified above. In particular, the matching model and selection process greatly reduces the total number of potential matches that could occur between the first entries in the first dataset and the second entries in the second dataset. Thus, when the language model is prompted to perform the computational matching task on the candidate matches, the number of tokens contained in the prompt is below the maximum token constraint of the language model. In this manner, the computer is improved because the computer can now use the language model to perform a large computational matching task that otherwise would be impossible for the computer to perform using the language model.

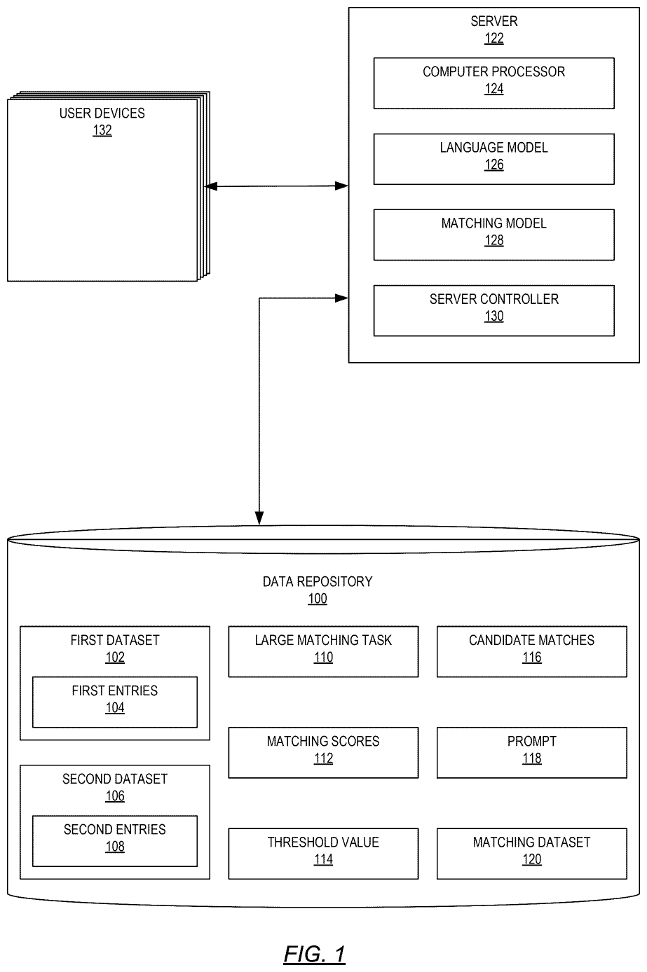

Attention is now turned to the figures. FIG. 1 shows a computing system, in accordance with one or more embodiments. The system shown in FIG. 1 includes a data repository (100). The data repository (100) is a type of storage unit or device (e.g., a file system, database, data structure, or any other storage mechanism) for storing data. The data repository (100) may include multiple different, potentially heterogeneous, storage units and/or devices.

The data repository (100) stores a first dataset (102). The first dataset (102) is a set of data stored in one or more data structures and may be stored in more than one data repository. For example, the first dataset (102) may be a set of transactions, a set of sensor measurements, a set of data intended for a data migration task, etc.

The first dataset (102) includes a number of first entries (104). Each of the first entries (104) represents a single entry in the first dataset (102). Thus, for example, a single transaction in a bank statement may be one of the first entries (104), or measurements by a single sensor at a particular time may be one of the first entries (104), etc.

Similarly, the data repository (100) stores a second dataset (106). Like the first dataset (102), the second dataset (106) is a set of data stored in one or more data structures and may be stored in more than one data repository. For example, the first dataset (102) may be a set of transactions, a set of sensor measurements, a set of data intended for a data migration task, etc.

However, the second dataset (106) is distinct from the first dataset (102). In particular, while the second dataset (106) may be related to the first dataset (102) in some manner, the second dataset (106) is different in at least one of type or content relative to the data contained in the first dataset (102).

The second dataset (106) may include second entries (108). Like the first entries (104), each of the second entries (108) represents a single entry in the second dataset (106). Thus, for example, a single transaction in an electronic ledger may be one of the second entries (108), or measurements by a single sensor (different than the sensor mentioned above) at a particular time may be one of the second entries (108), etc.

The data repository (100) also may store a large matching task (110). The large matching task (110) is a computer command to match the first dataset (102) to the second dataset (106). More particularly, the large matching task (110) is a command to match one or more of the first entries (104) to one or more of the second entries (108). In addition, the large matching task (110) is “large” in the sense that the number of tokens used to perform the large matching task (110), where the first dataset (102) is matched to the second dataset (106), would exceed a maximum token constraint of a language model (126) (defined below).

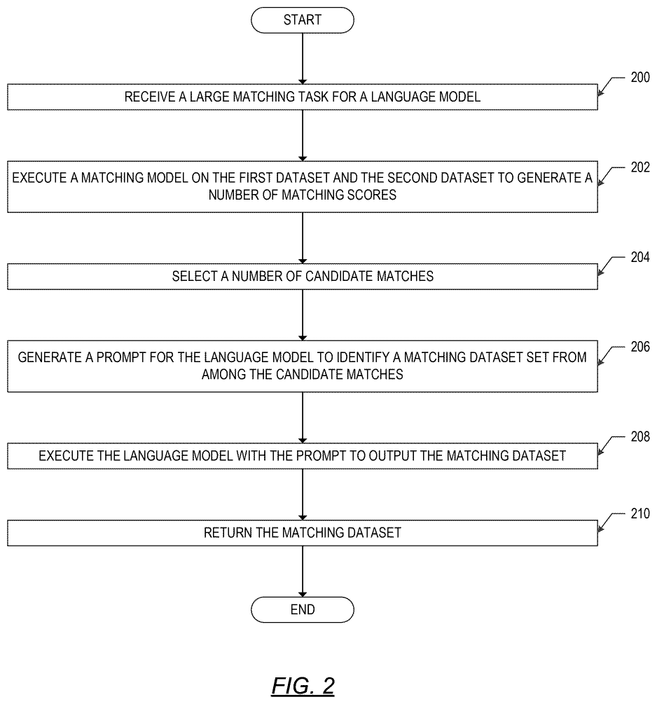

The data repository (100) also stores a number of matching scores (112). The matching scores (112) are scores output by a matching model (128) (defined below). In particular, each of the matching scores (112) represents a probability that one of the first entries (104) matches one the second entries (108) or a combination of multiple instances of the second entries (108). Generation of the matching scores (112) is described with respect to step 202 of FIG. 2.

The data repository (100) also stores a threshold value (114). The threshold value (114) is a number to which the matching scores (112) may be compared. Use of the threshold value (114) is described with respect to step 204 of FIG. 2. Briefly, the threshold value (114) is used to identify which of the possible matches identified by the matching model (128) will be considered candidate matches (116). In an example, the threshold value may be 95% (or 0.95), though different threshold values may be selected.

The data repository (100) also stores one or more candidate matches (116). The candidate matches (116) are possible matches between at least one of the first entries (104) and at least one of the second entries (108). In particular, the candidate matches (116) are those matches identified by the matching model (128) for which the matching scores (112) satisfy a threshold value (114). The term “satisfy” means equals, equals or exceeds, equals or is less than, or otherwise the comparison of the matching scores (112) to the threshold value (114) is computed to be satisfied according to some rule. Selecting the candidate matches is described with respect to step 204 of FIG. 2.

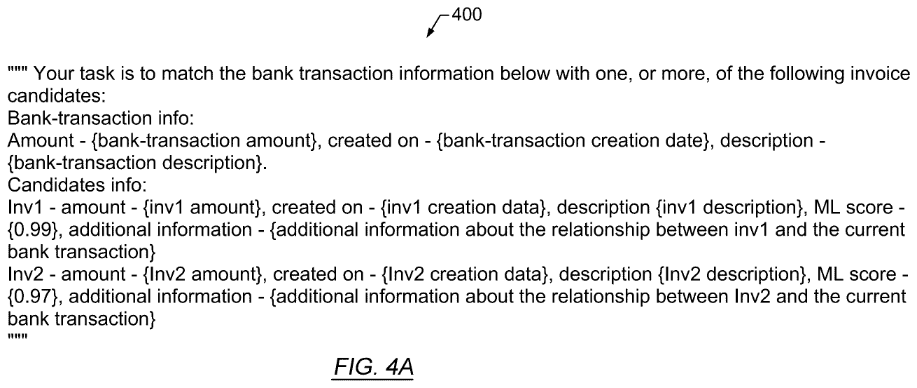

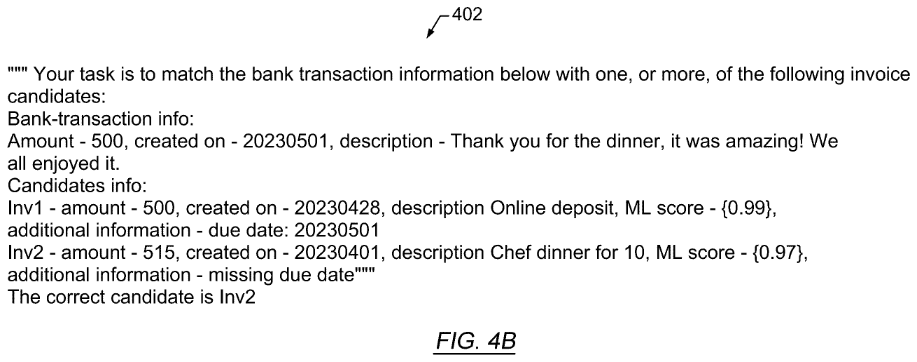

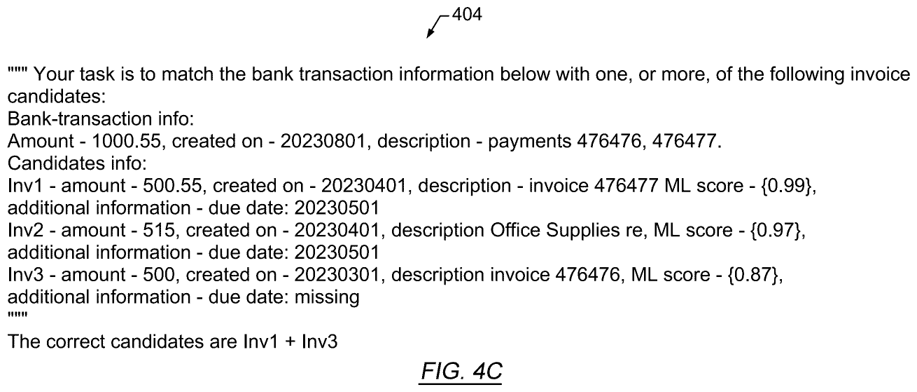

The data repository (100) also stores a prompt (118). The prompt (118) is alphanumeric text that instructs a language model (126) to generate a desired output. The prompt (118) may include instructions, may refer to a context (a specific source of data), may include system messages (general guidelines to the language model regarding how the language model should process the prompt (118)), may include data references, may include or reference data structures, etc. In the case of one or more embodiments, the prompt (118) includes at least the candidate matches (116) and a command to perform the matching task. Example prompts are shown in FIG. 4A through FIG. 4C. Generation of the prompt is described with respect to step 206 of FIG. 2.

The data repository (100) also may store a matching dataset (120). The matching dataset (120) is an output of the language model (126), or multiple outputs of the language model (126). The matching dataset (120) is a matching of the first entries (104) in the first dataset (102) to the second entries (108) in the second dataset (106). Generation of the matching dataset (120) is described with respect to step 208 of FIG. 2.

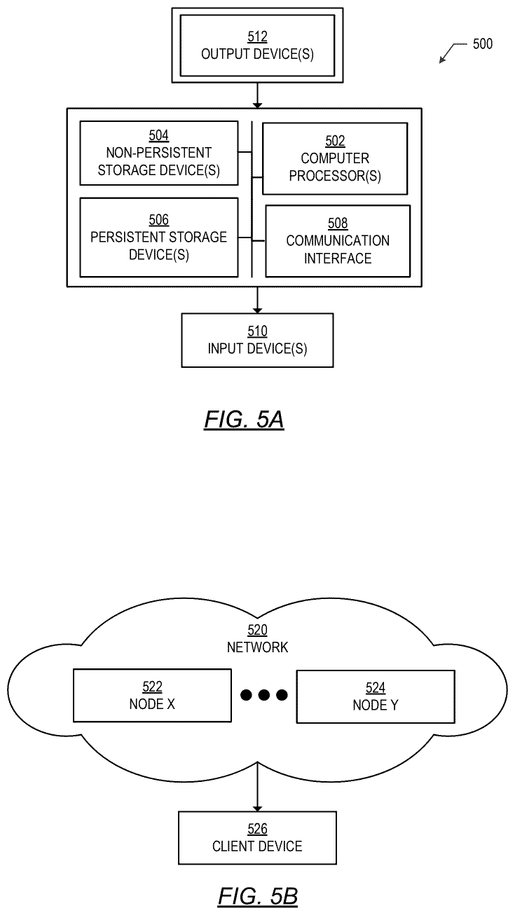

The system shown in FIG. 1A may include other components. For example, the system shown in FIG. 1A also may include a server (122). The server (122) is one or more computer processors, data repositories, communication devices, and supporting hardware and software. The server (122) may be in a distributed computing environment. The server (122) is configured to execute one or more applications, such as the language model (126), the matching model (128), or the server controller (130). An example of a computer system and network that may form the server (122) is described with respect to FIG. 5A and FIG. 5B.

The server (122) includes a computer processor (124). The computer processor (124) is one or more hardware or virtual processors which may execute computer readable program code that defines one or more applications, such as the language model (126), the matching model (128), or the server controller (130). An example of the computer processor (124) is described with respect to the computer processor(s) (502) of FIG. 5A.

The server (122) also includes a language model (126). The language model (126) is a natural language processing machine learning model. An example of the language model (126) may be a large language model, such as CHATGPT® by OpenAI LLC, GenOS, or Gemini by Google. However, many different language models may be used. Use of the language model (126) is described with respect to FIG. 2.

The server (122) also includes a matching model (128). The matching model (128) is a machine learning model programmed to match the first entries (104) of the first dataset (102) to the second entries (108) of the second dataset (106). However, again, the matching model (128) may be programmed to perform more complex matching tasks, such as to match entries among multiple additional datasets. The matching model (128) may be a supervised machine learning model. A supervised machine learning model is a model that is trained using data that is labeled with information known to be true or known to be false. In an embodiment, the matching model (128) may be a gradient boosting machine classifier, such as a Light Gradient Boosting Machine Classifier (LGBM). However, the matching model (128) may be other types of classification or matching machine learning models.

The matching model (128) may be referred to as a slim matching model. A matching model is a model programmed to perform a matching task. A “slim” model is a model that uses less then a predetermined amount of computing resources when executed on a dataset of a predetermined size. In particular, a “slim” model is less computationally expensive to execute than a large language model. Thus, a “slim matching model” is a slim machine learning model that is programmed to perform a matching task among multiple datasets.

However, the slim machine learning model may have an accuracy less than a predetermined matching accuracy specified for the large matching task (110). In other words, the matching model (128) (whether a slim matching model or some other matching model) is not capable of performing the desired large matching task (110) to the predetermined matching accuracy. However, in this case, the language model (126) does have at least the predetermined matching accuracy.

The machine learning models used by the system shown in FIG. 1 (i.e., the language model (126) and the matching model (128)) may include neural networks and may operate using one or more layers of weights that may be sequentially applied to sets of input data, which may be referred to as input vectors. For each layer of a machine learning model, the weights of the layer may be multiplied by the input vector to generate a collection of products, which may then be summed to generate an output for the layer that may be fed, as input data, to a next layer within the machine learning model. The output of the machine learning model may be the output generated from the last layer within the machine learning model. Multiple machine learning models may operate sequentially or in parallel. The output may be a vector or scalar value. The layers within the machine learning model may be different and correspond to different types of models. As an example, the layers may include layers for recurrent neural networks, convolutional neural networks, transformer models, attention layers, perceptron models, etc. Perceptron models may include one or more fully connected (also referred to as linear) layers that may convert between the different dimensions used by the inputs and the outputs of a model. Different types of machine learning algorithms may be used, including regression, decision trees, random forests, support vector machines, clustering, classifiers, principal component analysis, gradient boosting, etc.

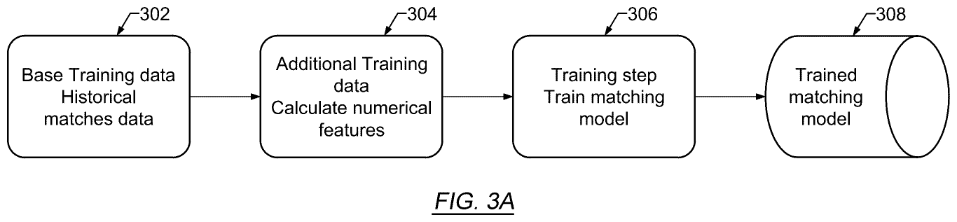

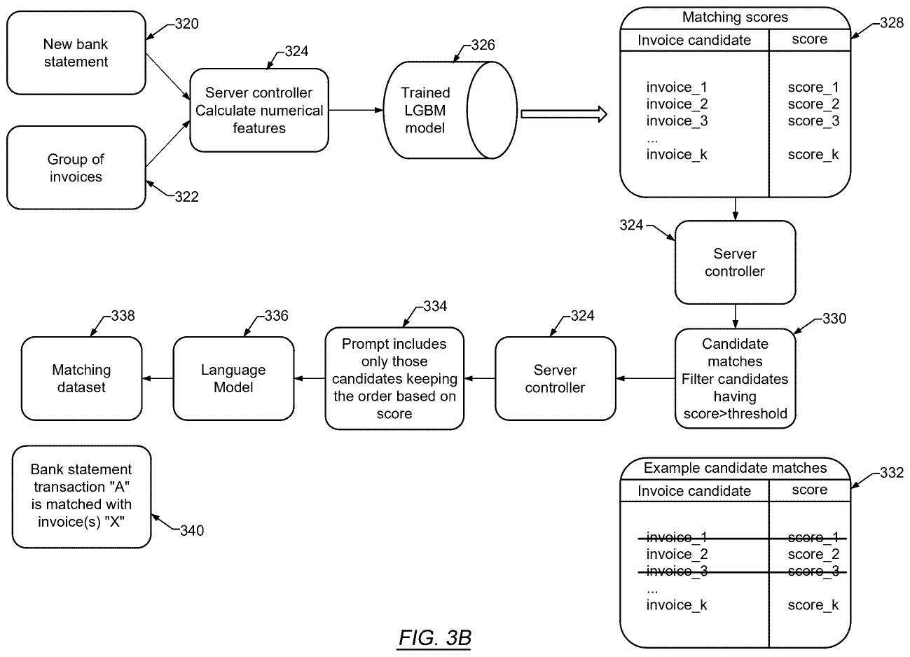

The server (122) also may include a server controller (130). The server controller (130) is software or application specific hardware which, when executed by the computer processor (124), controls and coordinates operation of the software or application specific hardware described herein. Thus, the server controller (130) may control and coordinate execution of the language model (126), the matching model (128), or the server controller (130). The server controller (130) may be programmed to execute the method of FIG. 2, for example, or the data flows shown in FIG. 3A or FIG. 3B.

The system shown in FIG. 1 also may include one or more user devices (132). The user devices (132) may be considered remote or local. A remote user device is a device operated by a third-party (e.g., an end user of a chatbot) that does not control or operate the system of FIG. 1. Similarly, the organization that controls the other elements of the system of FIG. 1 may not control or operate the remote user device. Thus, a remote user device may not be part of the system of FIG. 1.

In contrast, a local user device is a device operated under the control of the organization that controls the other components of the system of FIG. 1. Thus, a local user device may be considered part of the system of FIG. 1.

In any case, the user devices (132) are computing systems (e.g., the computing system (500) shown in FIG. 5A) that communicate with the server (122). Thus, the user devices (132) may be used to initiate or control the matching process described with respect to FIG. 2. In another embodiment, one or more of the user devices (132) may be operated by a computer technician that services the various components of the system shown in FIG. 1.

While FIG. 1 shows a configuration of components, other configurations may be used without departing from the scope of one or more embodiments. For example, various components may be combined to create a single component. As another example, the functionality performed by a single component may be performed by two or more components.

FIG. 2 shows a flowchart of a method for overcoming token constraints in language models applied to matching tasks, in accordance with one or more embodiments. The method of FIG. 2 may be implemented using the system of FIG. 1 and one or more of the steps may be performed on or received at one or more computer processors.

Step 200 includes receiving a large matching task for a language model. The large matching task includes a request to match a first dataset to a second dataset. The request exceeds a maximum token constraint of the language model. The large matching task may be received from a user device. The large matching task may be called by an external process. The large matching task may be received from a server controller. The large matching task may be received from other sources.

Step 202 includes executing a matching model on the first dataset and the second dataset to generate a number of matching scores. Each of the matching scores represents a probability of match between a first entry in the first dataset and one of a number of second entries in the second dataset.

The matching model may be executed on the first and second datasets by a number of different techniques. In an embodiment, the first and second datasets may be provided directly as input to the matching model. In another embodiment, the first and second datasets may be converted to one or more vectors (e.g., a single vector known as a “one hot vector”) and then provided as input to the matching model. A processor executes the algorithm that defines the matching model, taking the first and second datasets as input.

Thus, for example, assume 10 entries exist in a first dataset and 10 entries in a second dataset. Then, the matching model may generate up to 100 matching scores. Specifically, an initial one of the first entries will have 10 scores, one per each of the second entries; and a second one of the first entries will have 10 scores, one per each of the second entries, etc. However, the number of matching scores may be truncated for matching scores below a lower threshold value. In another example, if a matching score for a potential match between two entries is below the lower threshold value, then the matching score may be discarded. In this manner, the number of matching scores (and thus the number of candidate matches at step 204) may be reduced to increase the computational efficiency of the method of FIG. 2.

Step 204 includes selecting a number of candidate matches. The candidate matches include matches between the first entry and a subset of the second entries. In most cases, the number of subset of the second entries is less than a full set of the second entries. The matches have selected matching scores among the matching scores. The selected matching cores exceed a threshold value.

Stated differently, the number of candidate matches are selected by comparing the matching scores of various matches to a threshold value. Scores having values that satisfy the threshold value are retained. Those matches between the first entry of the first dataset and second entries in the second dataset that have the scores that satisfy the threshold value are also retained. Such retained matches are the candidate matches.

The process may be repeated for each match between other entries in the first dataset and one or more of the entries in the second dataset. Thus, in an embodiment, each of the entries in the first dataset is associated with one or more potential matches to second entries in the second dataset. Each such match having a score that satisfies the threshold value is a candidate match.

Once the process of selecting the candidate matches is completed, the number of candidate matches is determined. The method of FIG. 2 then may continue.

Step 206 includes generating a prompt for the language model to identify a matching dataset set from among the candidate matches. The prompt may be generated by a number of different techniques.

In one embodiment, generating the prompt includes retrieving a prompt template including prompt instructions to match a first data subset and a second data subset. An example of a prompt template is shown in FIG. 4A. The prompt template includes fields or blocks where the candidate matches, or references to the candidate matches, may be inserted into the prompt template.

Then, the first entry may be added to the prompt as the first data subset. The second entries also are added to the prompt as the second data subset. Examples of filled-in prompts having the first entry and second entries inserted are shown in FIG. 4B and FIG. 4C.

The prompt may include the matching scores described above, particularly when more than one candidate match or set of matches in the second entries of the second datasets exists for one of the first entries in the first dataset. In other words, the candidate matches include multiple selections for possible matches between a given entry in the first dataset and different entries in the second dataset. Addition of the matching scores to the prompt, and associating the matching scores with the candidate matches, may increase the accuracy of the language model when the language model is executed at step 208, below.

In an embodiment, the prompt may include multiple commands. Each of the commands represents one of the potential candidate matches between another entry in the first dataset and one or more second entries in the second dataset.

In a different embodiment, multiple prompts may be generated to process multiple commands. Thus, for example, many different prompts are prepared with each prompt representing a command to match one (or more) of the first entries in the first dataset with one (or more) of the second entries in the second dataset.

Step 208 includes executing the language model with the prompt to output the matching dataset. Executing the language model includes providing the prompt, or prompts, generated at step 206 to a language model and then commanding a processor to execute the language model with the prompt. The output of the language model is the matching dataset. An example of step 208 also is shown in FIG. 4B and FIG. 4C.

If a single prompt is generated at step 206, then the language model is executed once; however, the output includes multiple matching datasets. For example, the output contains each of multiple first entries in the first dataset matched to one or more second entries in the second dataset.

If multiple prompts are generated at step 206, then the language model may be executed multiple times. In this case, multiple outputs are generated, each containing one or more matching datasets. In an embodiment, the matching datasets may be collated and presented as a single matching dataset.

Step 210 includes returning the matching dataset. Returning the matching dataset may include displaying the matching dataset on a display device. Returning the matching dataset also may include storing the matching dataset in a data repository or non-transitory computer readable storage medium. Returning the matching dataset also may include transmitting the matching dataset to another computing process. For example, if the matching dataset is bank transactions matched to entries in a digital ledger, then the matching dataset may be transmitted to a financial management application for further processing. Thus, returning the matching dataset includes passing the matching dataset to a processing algorithm programmed to use the matching dataset to output a result.

The method of FIG. 2 may be varied. For example, the method of FIG. 2 may include more, fewer, or revised steps.

For example, the method of FIG. 2 may include repeating, for each additional entry in the first dataset, executing the matching model, selecting, generating, executing the language model, and returning. In this case, repeating generates matching datasets in addition to (and including) the matching dataset. The resulting multiple matching datasets may be returned, as described with respect to step 210.

The method of FIG. 2 also may be extended to include a training step, particularly to train the matching model. For example, assume that the matching model is a supervised machine learning model. In this case, the method may include training the supervised machine learning model on training data including a first sample dataset, a second sample dataset, and a number of known matches between first entries in the first sample dataset and second entries in the second sample dataset. In this manner, the accuracy of the matching model may be improved.

In an embodiment, differences in time between the first dataset and the second dataset may be included in the training data. The addition of the time differences may further improve the accuracy of the matching model when trained or retrained.

The machine learning models may be trained by inputting training data to a machine learning model to generate training outputs that are compared to expected outputs. For supervised training, the expected outputs may be labels associated with a given input. The difference between the training output and the expected output may be processed with a loss function to identify updates to the weights of the layers of the model. After training on a batch of inputs, the updates identified by the loss function may be applied to the machine learning model to generate a trained machine learning model. Different algorithms may be used to determine and apply the updates to the machine learning model, including back propagation, gradient descent, etc. A data flow for training the matching model (128) is shown in FIG. 3A.

While the various steps in the flowchart of FIG. 2 are presented and described sequentially, at least some of the steps may be executed in different orders, may be combined or omitted, and at least some of the steps may be executed in parallel. Furthermore, the steps may be performed actively or passively.

FIG. 3A shows a dataflow of a method for training a matching model, in accordance with one or more embodiments. The dataflow shown in FIG. 3A and the method of FIG. 3B are described with respect to matching a bank statement (a first dataset, where each of the first entries are individual transactions in the statement) to electronic invoices (a second dataset, where each of the second entries are individual transactions in the electronic invoices). Note that while the examples of FIG. 3A and FIG. 3B represent an application of one or more embodiments to a financial setting, one or more embodiments are not directed to financial matching. Rather, one or more embodiments are directed to the improvements of FIG. 1 and FIG. 2 that permit a language model to perform a large matching task, and the examples of FIG. 3A and FIG. 3B illustrate the procedure of one or more embodiments.

Initially, base training data (302) is provided. The base training data (302) includes historical matches performed using like datasets. Thus, the base training data (302) is matching datasets among different matching tasks between bank statements and invoices. Each of the historical matches are labeled as having been correctly matched.

In an embodiment, additional training data (304) may be added to the base training data (302). The additional training data (304) includes numerical features, such as the difference in amount between the invoice and the bank transaction, the time disparity between bank transactions and the creation of the invoice, other types of data, and combinations thereof.

Then, a training controller executes a training step (306). The training step trains the matching model according to the training method described above with respect to one of the alternative embodiments to the method of FIG. 2. The result of the training step (306) is a trained matching model (308). The trained matching model (308) then may be used in the dataflow of FIG. 3B.

FIG. 3B shows an example of a dataflow for a particular method for overcoming token constraints in language models applied to matching tasks, in accordance with one or more embodiments. The dataflow of FIG. 3B may be performed after training the trained matching model (308) in the dataflow of FIG. 3A. The dataflow of FIG. 3B also is an example of the method of FIG. 2 but showing the components that perform the steps.

In the dataflow of FIG. 3B, a command is received to match a new bank statement (320) to a group of invoices (322). The resulting computational matching task is, in the example, a large computational task. Thus, the process of matching the new bank statement (320) to the group of invoices (322), if not for one or more embodiments, exceeds the maximum token constraint of the language model (336) (mentioned below). Thus, the process of directly matching the new bank statement (320) to the group of invoices (322) may not be performed by the language model (336).

The new bank statement (320) and the group of invoices (322) are provided to a server controller (324). The server controller (324) may determine numerical features for the new bank statement (320) and the group of invoices (322). The numerical features may include the numerical features described above with respect to FIG. 3A (e.g., the differences in amounts and the time differences between the entries in the new bank statement (320) and the entries in the group of invoices (322)). In an embodiment, determination of the numerical features may be omitted.

Next, the server controller (324) passes the new bank statement (320) and the group of invoices (322), possibly together with the numerical features, to the trained LGBM model (326). The term “LGBM” stands for “Light Gradient Boosting Machine Classifier.” The new bank statement (320) and the group of invoices (322), possibly together with the numerical features, are features that are combined into a vector that serve as the input to the trained LGBM model (326).

The trained LGBM model (326) is then executed. The output of the trained LGBM model (326) is the matching scores (328) shown. The matching scores (328) show the probabilities that a given invoice in the group of invoices (322) matches one or more entries in the new bank statement (320). While the matching scores (328) in FIG. 3B show one invoice per score, in an embodiment, a single invoice may be associated with multiple scores if a single invoice potentially matches more than one of the entries in the new bank statement (320).

The matching scores (328) are transmitted to the server controller (324). The server controller (324) determines the candidate matches (330), as described with respect to step 204 of FIG. 2. Briefly, the potential matches determined by the matching scores (328) are compared to a threshold value of 0.95. Those matches having matching scores that satisfy the threshold (i.e., are at or above 0.95) are considered candidate matches. The remaining matches have scores that do not satisfy the threshold, and thus are not considered to be among the candidate matches (330).

Example candidate matches (332) are shown to indicate that two of the potential matches are eliminated. Thus, the number of candidate matches is less than the number of matching scores (328). Note that, in real practice, many (if not most) of the potential matches for which a matching score was determined, are eliminated by the server controller (324) when selecting the candidate matches (330).

Next, the server controller (324) generates a prompt (334). The prompt (334) may generate the prompt according to step 206 of FIG. 2. Briefly, the prompt (334) is drawn from a prompt template (shown in FIG. 4A). The candidate matches, together with the corresponding scores assigned to the candidate matches, are included in the prompt. The candidate matches may be listed in order of the scores in order to increase the accuracy of the language model (336). Examples of the final prompt passed to the language model (336) are shown in FIG. 4B and FIG. 4C.

The prompt (334) is then provided to the language model (336). A processor executes the language model (336) with the prompt (334). The output of the language model (336) is the matching dataset (338). Examples of the output of the language model (336) are also shown in FIG. 4B and FIG. 4C. In an embodiment, the final output (340) is a text message indicating the matching dataset.

FIG. 4A through FIG. 4C shows example prompts for use in the method of FIG. 2 or the dataflow of FIG. 3B, in accordance with one or more embodiments. The prompts shown in FIG. 4A through FIG. 4C may be used in the dataflow described with respect to FIG. 3B or in the method described with respect to FIG. 2. The prompts shown in FIG. 4A through FIG. 4C may be the prompt (118) shown in FIG. 1.

The prompt template (400) shown in FIG. 4A is an example of a prompt template that may be used to generate a prompt at step 206 of FIG. 2 or the prompt (334) of FIG. 3B. The prompt template (400) includes a command (i.e., “Your task . . . ”), a template for bank transaction information (i.e., “Bank-transaction info:” together with the template for entering information for the bank transaction), and a template for invoice information (i.e., “Candidates info:” together with the template for entering information for the invoices).

The prompt (402) shown in FIG. 4B shows the command (i.e., “Your task...”), and the filled-in template blocks for “Bank transaction info” and “Candidates info.” As shown, the bank transaction (i.e., the first entry in the first dataset) is possibly matchable with two invoices (i.e., two of the second entries in the second dataset). In other words, two candidate matches are entered into the prompt (402) with respect to the one of the first entries in the first dataset. The scores associated with each potential match of a given invoice to the bank transaction are also shown in descending order of the probability of match.

The output of executing the prompt is also shown. The last line in FIG. 4B states, “The correct candidate is Inv2.” In other words, the output of the language model is that the correct invoice that matches the bank transaction in the prompt is “Inv2.”

The prompt (404) shown in FIG. 4B shows the command (i.e., “Your task . . . ”), and the filled-in template blocks for “Bank transaction info” and “Candidates info.” As shown, the bank transaction (i.e., the first entry in the first dataset) is possibly matchable with three invoices (i.e., three of the second entries in the second dataset). In other words, three candidate matches are entered into the prompt (404) with respect to the one of the first entries in the first dataset. The scores associated with each potential match of a given invoice to the bank transaction are also shown in descending order of the probability of match. Note that the threshold value is lowered in the example of FIG. 4C, as one of the candidate matches has a probability of 0.87 (meaning the threshold value in the example prompt is 0.87 or lower).

The output of executing the prompt is also shown. The last line in FIG. 4C states, “The correct candidates are Inv1 +Inv3.” In other words, the output of the language model is that the correct invoices that matches the bank transaction in the prompt are the combination of “Inv1” and “Inv3.” Accordingly, the example language model output based on the prompt shown in FIG. 4C shows that the language model may determine that multiple invoices are combined in order to match a single bank transaction.

The capability of matching multiple second entries of a second dataset to a single entry of a first dataset is a useful feature of a language model and is not a capability of the trained LGBM model (326) in FIG. 3B. However, without one or more embodiments, the matching task could not have been performed with the language model, as the initial matching task exceeded the maximum token constraint of the language model. Thus, the output shown in FIG. 4C illustrates one possible utility of one or more embodiments.

One or more embodiments may be implemented on a computing system specifically designed to achieve an improved technological result. When implemented in a computing system, the features and elements of the disclosure provide a significant technological advancement over computing systems that do not implement the features and elements of the disclosure. Any combination of mobile, desktop, server, router, switch, embedded device, or other types of hardware may be improved by including the features and elements described in the disclosure.

For example, as shown in FIG. 5A, the computing system (500) may include one or more computer processor(s) (502), non-persistent storage device(s) (504), persistent storage device(s) (506), a communication interface (508) (e.g., Bluetooth interface, infrared interface, network interface, optical interface, etc.), and numerous other elements and functionalities that implement the features and elements of the disclosure. The computer processor(s) (502) may be an integrated circuit for processing instructions. The computer processor(s) (502) may be one or more cores, or micro-cores, of a processor. The computer processor(s) (502) includes one or more processors. The computer processor(s) (502) may include a central processing unit (CPU), a graphics processing unit (GPU), a tensor processing unit (TPU), combinations thereof, etc.

The input device(s) (510) may include a touchscreen, keyboard, mouse, microphone, touchpad, electronic pen, or any other type of input device. The input device(s) (510) may receive inputs from a user that are responsive to data and messages presented by the output device(s) (512). The inputs may include text input, audio input, video input, etc., which may be processed and transmitted by the computing system (500) in accordance with one or more embodiments. The communication interface (508) may include an integrated circuit for connecting the computing system (500) to a network (not shown) (e.g., a local area network (LAN), a wide area network (WAN) such as the Internet, mobile network, or any other type of network) or to another device, such as another computing device, and combinations thereof.

Further, the output device(s) (512) may include a display device, a printer, external storage, or any other output device. One or more of the output device(s) (512) may be the same or different from the input device(s) (510). The input device(s) (510) and output device(s) (512) may be locally or remotely connected to the computer processor(s) (502). Many different types of computing systems exist, and the aforementioned input device(s) (510) and output device(s) (512) may take other forms. The output device(s) (512) may display data and messages that are transmitted and received by the computing system (500). The data and messages may include text, audio, video, etc., and include the data and messages described above in the other figures of the disclosure.

Software instructions in the form of computer readable program code to perform embodiments may be stored, in whole or in part, temporarily or permanently, on a non-transitory computer readable medium such as a solid state drive (SSD), compact disk (CD), digital video disk (DVD), storage device, a diskette, a tape, flash memory, physical memory, or any other computer readable storage medium. Specifically, the software instructions may correspond to computer readable program code that, when executed by the computer processor(s) (502), is configured to perform one or more embodiments, which may include transmitting, receiving, presenting, and displaying data and messages described in the other figures of the disclosure.

The computing system (500) in FIG. 5A may be connected to, or be a part of, a network. For example, as shown in FIG. 5B, the network (520) may include multiple nodes (e.g., node X (522) and node Y (524), as well as extant intervening nodes between node X (522) and node Y (524)). Each node may correspond to a computing system, such as the computing system shown in FIG. 5A, or a group of nodes combined may correspond to the computing system shown in FIG. 5A. By way of an example, embodiments may be implemented on a node of a distributed system that is connected to other nodes. By way of another example, embodiments may be implemented on a distributed computing system having multiple nodes, where each portion may be located on a different node within the distributed computing system. Further, one or more elements of the aforementioned computing system (500) may be located at a remote location and connected to the other elements over a network.

The nodes (e.g., node X (522) and node Y (524)) in the network (520) may be configured to provide services for a client device (526). The services may include receiving requests and transmitting responses to the client device (526). For example, the nodes may be part of a cloud computing system. The client device (526) may be a computing system, such as the computing system shown in FIG. 5A. Further, the client device (526) may include or perform all or a portion of one or more embodiments.

The computing system of FIG. 5A may include functionality to present data (including raw data, processed data, and combinations thereof) such as results of comparisons and other processing. For example, presenting data may be accomplished through various presenting methods. Specifically, data may be presented by being displayed in a user interface, transmitted to a different computing system, and stored. The user interface may include a graphical user interface (GUI) that displays information on a display device. The GUI may include various GUI widgets that organize what data is shown, as well as how data is presented to a user. Furthermore, the GUI may present data directly to the user, e.g., data presented as actual data values through text, or rendered by the computing device into a visual representation of the data, such as through visualizing a data model.

As used herein, the term “connected to” contemplates multiple meanings. A connection may be direct or indirect (e.g., through another component or network). A connection may be wired or wireless. A connection may be a temporary, permanent, or a semi-permanent communication channel between two entities.

The various descriptions of the figures may be combined and may include, or be included within, the features described in the other figures of the application. The various elements, systems, components, and steps shown in the figures may be omitted, repeated, combined, or altered as shown in the figures. Accordingly, the scope of the present disclosure should not be considered limited to the specific arrangements shown in the figures.

In the application, ordinal numbers (e.g., first, second, third, etc.) may be used as an adjective for an element (i.e., any noun in the application). The use of ordinal numbers is not to imply or create any particular ordering of the elements, nor to limit any element to being only a single element unless expressly disclosed, such as by the use of the terms “before,” “after,” “single,” and other such terminology. Rather, ordinal numbers distinguish between the elements. By way of an example, a first element is distinct from a second element, and the first element may encompass more than one element and succeed (or precede) the second element in an ordering of elements.

Further, unless expressly stated otherwise, the conjunction “or” is an inclusive “or” and, as such, automatically includes the conjunction “and,” unless expressly stated otherwise. Further, items joined by the conjunction “or” may include any combination of the items with any number of each item, unless expressly stated otherwise.

In the above description, numerous specific details are set forth in order to provide a more thorough understanding of the disclosure. However, it will be apparent to one of ordinary skill in the art that the technology may be practiced without these specific details. In other instances, well-known features have not been described in detail to avoid unnecessarily complicating the description. Further, other embodiments not explicitly described above can be devised which do not depart from the scope of the claims as disclosed herein. Accordingly, the scope should be limited only by the attached claims.

What is claimed is:

1. A method for executing a large matching task by a language model, the large matching task comprising a request to the language model to match a first dataset to a second dataset in which the request exceeds a maximum token constraint of the language model, the method comprising:
receiving the large matching task for the language model,
executing a matching model on the first dataset and the second dataset to generate a plurality of matching scores, wherein each of the plurality of matching scores represents a probability of match between a first entry in the first dataset and one of a plurality of second entries in the second dataset;
selecting a plurality of candidate matches between the first entry and a subset of the plurality of second entries,
wherein the matches have selected matching scores among the plurality of matching scores, and
wherein the selected matching scores exceed a threshold value;
generating a prompt for the language model to identify a matching dataset set from among the plurality of candidate matches;
executing the language model with the prompt to output the matching dataset; and
returning the matching dataset.

2. The method of claim 1, further comprising:
repeating, for each additional entry in the first dataset, executing the matching model, selecting, generating, executing the language model, and returning, wherein repeating generates a plurality of matching datasets including the matching dataset; and
returning the plurality of matching datasets.

3. The method of claim 1,
wherein the matching model comprises a supervised machine learning model, and
wherein the method further comprises training the supervised machine learning model on training data comprising a first sample dataset, a second sample dataset, and a plurality of known matches between first entries in the first sample dataset and second entries in the second sample dataset.

4. The method of claim 3, wherein the training data further comprises differences in time between the first dataset and the second dataset.

5. The method of claim 3, wherein:
the matching model comprises a slim matching model,
the slim matching model comprises a matching accuracy less than a predetermined matching accuracy specified for the large matching task, and
the language model comprises at least the predetermined matching accuracy.

6. The method of claim 3, wherein the matching model comprises a gradient boosting machine classifier.

7. The method of claim 1, wherein generating the prompt comprises:
retrieving a prompt template comprising prompt instructions to match a first data subset and a second data subset,
adding the first entry to the prompt as the first data subset, and
adding the plurality of second entries to the prompt as the second data subset.

8. The method of claim 1, wherein returning the matching dataset comprises passing the matching dataset to a processing algorithm programmed to use the matching dataset to output a result.

9. The method of claim 1, wherein returning the matching dataset comprises storing the matching dataset in a data repository.

10. A system comprising:
a computer processor;
a data repository in communication with the computer processor and storing:
a first dataset,
a second dataset,
a large matching task comprising a request to match the first dataset to the second dataset, wherein the request exceeds a maximum token constraint of a language model,
a plurality of matching scores, wherein each of the plurality of matching scores represents a probability of match between a first entry in the first dataset and one of a plurality of second entries in the second dataset,
a plurality of candidate matches, wherein the plurality of candidate matches comprise matches between the first entry and a subset of the plurality of second entries that have selected matching scores among the plurality of matching scores, wherein the selected matching scores exceed a threshold value,
a prompt for the language model to identify a matching dataset set from among the plurality of candidate matches, and the matching dataset;
the language model executable by the computer processor;
a matching model executable by the computer processor; and
a server controller programmed, when executed by the computer processor, to perform a computer-implemented method comprising:
receiving the large matching task,
executing the matching model on the first dataset and the second dataset to generate the plurality of matching scores,
selecting the plurality of candidate matches,
generating the prompt,
executing the language model with the prompt to output the matching dataset, and
returning the matching dataset.

11. The system of claim 10, wherein the computer-implemented method further comprises:
repeating, for each additional entry in the first dataset, executing the matching model, selecting, generating, executing the language model, and returning, wherein repeating generates a plurality of matching datasets including the matching dataset; and
returning the plurality of matching datasets.

12. The system of claim 10,
wherein the matching model comprises a supervised machine learning model, and
wherein the system further comprises a training controller programmed, when executed by the computer processor, to train the supervised machine learning model on training data comprising a first sample dataset, a second sample dataset, and a plurality of known matches between first entries in the first sample dataset and second entries in the second sample dataset.

13. The system of claim 12, wherein the training data further comprises differences in time between the first dataset and the second dataset.

14. The system of claim 10, wherein:
the matching model comprises a slim matching model,
the slim matching model comprises a matching accuracy less than a predetermined matching accuracy specified for the large matching task, and
the language model comprises at least the predetermined matching accuracy.

15. The system of claim 10, wherein the matching model comprises a gradient boosting machine classifier.

16. The system of claim 10, wherein the server controller is further programmed to generate the prompt by:
retrieving a prompt template comprising prompt instructions to match a first data subset and a second data subset,
adding the first entry to the prompt as the first data subset, and
adding the plurality of second entries to the prompt as the second data subset.

17. The system of claim 10, wherein the server controller is further programmed to return the matching dataset by passing the matching dataset to a processing algorithm programmed to use the matching dataset to output a result.

18. The system of claim 10, wherein the server controller is further programmed to return the matching dataset by storing the matching dataset in a data repository.

19. A method for executing a large matching task by a language model, the large matching task comprising a request to the language model to match a first dataset to a second dataset in which the request exceeds a maximum token constraint of the language model, the method comprising:
receiving the large matching task for the language model;
executing a gradient boosting machine classifier on the first dataset and the second dataset to generate a plurality of matching scores, wherein:
each of the plurality of matching scores represents a probability of match between a first entry in the first dataset and one of a plurality of second entries in the second dataset,
the gradient boosting machine classifier comprises a slim matching model,
the slim matching model comprises a matching accuracy less than a predetermined matching accuracy specified for the large matching task, and
the language model comprises at least the predetermined matching accuracy;
selecting a plurality of candidate matches comprising matches between the first entry and a subset of the plurality of second entries, wherein the matches have selected matching scores among the plurality of matching scores, and wherein the selected matching scores exceed a threshold value;
generating a prompt for the language model to identify a matching dataset set from among the plurality of candidate matches, wherein generating the prompt comprises:
retrieving a prompt template comprising prompt instructions to match a first data subset and a second data subset,
adding the first entry to the prompt as the first data subset, and
adding the plurality of second entries to the prompt as the second data subset;
executing the language model with the prompt to output the matching dataset;
repeating, for each additional entry in the first dataset, executing the matching model, selecting, generating, executing the language model, and returning, wherein repeating generates a plurality of matching datasets including the matching dataset; and
returning the plurality of matching datasets.

20. The method of claim 19, further comprising:
categorizing the first dataset and the second dataset according to the plurality of matching datasets.
